(19) United States
(12) Patent Application Publication
(10) Pub. No.: US 2007/0041437 A1
(43) Pub. Date: Feb. 22, 2007

(54) BIT ERROR PROBABILITY ESTIMATING SYSTEM AND RELATED METHOD THEREOF

(76) Inventors: Chun-Ming Kuo, Taipei Hsien (TW); Ho-Chi Huang, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/161,823

(22) Filed: Aug. 18, 2005

(51) Int. Cl. H04B 17/00

(52) U.S. Cl. 375/227

(57) ABSTRACT

According to the claimed invention, a bit error probability (BEP) estimating system and method for determining the BEP of a received signal are disclosed. The BEP estimating system includes: a soft equalizer for generating a plurality of soft outputs according to the received signal; a calibration apparatus for deriving a first parameter and a second parameter, wherein the second parameter is relative to the first parameter; and a computing module, coupled to the soft equalizer and selectively coupled to the calibration apparatus, for determining the BEP according to the soft outputs, the first parameter, and the second parameter.

### BACKGROUND

The invention relates to an Enhanced GPRS (EGPRS) system and a related method thereof, and more particularly, to a bit error probability estimating system applied to the EGPRS system and related method thereof.

The performance of a digital communication of a mobile or wireless radio transmission system is constrained by non-ideal transmission channel. In these non-ideal transmission channel, multipath propagation, fading environment, inter symbol interference (ISI), and impulse noise etc., may result in high transmission error probability.

In the EGPRS communication system, the bit error probability is an important feature of the transmission performance. Each Radio Link Control (RLC) block of the EGPRS system is encoded and modulated according to the nine normal modulation and coding schemes (i.e., MCS-1, MCS-2, MCS-3, MCS-4, MCS-5, MCS-6, MCS-7, MCS-8, MCS-9). To optimize the throughput, the EGPRS communication system provides a link adaptation algorithm to select a proper modulation and coding scheme based on a channel quality report. The channel quality report comprises the characteristics of BEP (bit error probability), which are MEAN_BEP and CV_BEP, as an indicator of the channel quality in an EGPRS system.

One conventional BEP estimating method generates the BEP by comparing two data streams. One is the known bit stream transmitted to the receiver and the other is a series of reconstructed data of the received signal of the receiver. In an ideal environment, the two data streams should be the same. In reality, however, there are often some differences between the two data streams. This difference between data streams is utilized to generate the actual BEP. The smaller the difference (and therefore the BEP) between data streams, the larger the portion of the data stream needs to be utilized for generating the BEP. The conventional BEP estimating system mentioned above therefore may need to spend a lot of time to generate the BEP. On the other hand, the conventional reconstruction approach compares the data streams on a block-by-block basis. However, in EGPRS system, for MEAN_BEP and CV_BEP reporting purposes, the received signal quality for each channel shall be measured on a burst-by-burst basis in a manner that can be related to the BEP (Bit Error Probability) for each burst before channel decoding using, for example, soft output from the receiver. Therefore, the conventional method is not suitable to EGPRS system.

Another conventional way to generate the BEP is by a statistic theorem. A conventional BEP estimating apparatus comprises a soft equalizer and a computing module. The soft equalizer generates a soft output Lᵢ according to the log-likelihood ratio (LLR). The operation of the soft equalizer is shown in the following equation:

$${L}_{i} = a \cdot log \frac{p ( y \text{\textbar} {x}_{i} = 0 )}{p ( y \text{\textbar} {x}_{i} = 1 )} \qquad Equation ( 1 )$$

In Equation (1), “xᵢ” denotes the transmitted signal of index i, “y” denotes the received signal vector, and “a” denotes a scaling factor related to the design of the soft equalizer and the front-end component of the receiver. It is assumed that x₁=0 is transmitted if Lᵢ≧0, whereas x₁=1 is transmitted if Lᵢ<0. Without loss of generosity, a prior probability of p(x₁=0) and p(x₁=1) can be assumed to be equal. The soft output Lᵢ is generated according to the probability of received signal vector “y” assuming that the transmitted signal “x₁” is equal to “0”, and the probability of received signal vector “y” assuming that the transmitted signal “x₁” is equal to 1. For example, assuming the scaling factor “a” is 1, and the received signal vector is “y”, the soft equalizer firstly calculates the probability p(y|x₁=0)=0.1 and the probability p(y|x₁=1)=0.9. Therefore, the corresponding soft output Lᵢ should be 1*log(0.1/0.9)=−0.954.

After the soft equalizer has generated a plurality of soft outputs, the computing module calculates the BEP according to the statistic theorem expressed as:

$$\begin{matrix}E [ BEP ] = \{ \begin{matrix}\frac{p ( {x}_{i} = 1 \text{\textbar} y )}{p ( {x}_{i} = 0 \text{\textbar} y ) + p ( {x}_{i} = 1 \text{\textbar} y )} & if {L}_{i} \geq 0 \\ \frac{p ( {x}_{i} = 0 \text{\textbar} y )}{p ( {x}_{i} = 0 \text{\textbar} y ) + p ( {x}_{i} = 1 \text{\textbar} y )} & if {L}_{i} < 0\end{matrix} \\ = E [ \frac{1}{1 + {ⅇ}^{{a}^{- 1} \cdot \vert {L}_{i} \vert}} ]\end{matrix} \qquad Equation ( 2 )$$

In Equation (2), in order to obtain the BEP, the computing module must utilize the soft output Lᵢ to execute the dividing process and the exponential process. Because both processes require a lot of computation, the requirement of the computing performance of the conventional BEP estimating apparatus mentioned above is strict, and also consumes a vast amount of computing power at the same time. As a result, the conventional BEP estimating apparatus mentioned above may not be affordable in mobile handsets from the point of view of available DSP capability and power consumption.

### SUMMARY

It is therefore one of the objectives of the claimed invention to provide a BEP estimating system and related method with less computation to solve the above-mentioned problem.

Another objective of the claimed invention is to provide a low power consuming BEP estimating system and related method.

According to the claimed invention, a bit error probability (BEP) estimating system for determining the BEP of a received signal is disclosed. The BEP estimating system comprises: a soft equalizer for generating a plurality of soft outputs according to the received signal; a calibration apparatus for deriving a first parameter and a second parameter, wherein the second parameter is relative to the first parameter; and a computing module, coupled to the soft equalizer and selectively coupled to the calibration apparatus, for determining the BEP according to the soft outputs, the first parameter, and the second parameter.

According to the claimed invention, a BEP estimating system for determining the BEP of a received signal is disclosed. The BEP estimating system comprises: a soft equalizer for generating a plurality of soft outputs according to the received signal; a calibration apparatus for deriving a first parameter and a second parameter, wherein the second parameter is relative to the first parameter; an absolute value generating unit coupled to the soft equalizer, for generating a plurality of absolute values of the soft outputs; a first scaling unit coupled to the absolute value generating unit and selectively coupled to the calibration apparatus, for multiplying each absolute value by the first parameter to generate a plurality of computing values; an exponential value generating unit coupled to the first scaling unit, for generating a plurality of exponential values according to the computing values respectively, where a exponential value is substantially equal to 2 to a power of the computing value; a mean value generating unit coupled to the exponential value generating unit, for generating an averaged value of the exponential values outputted from the exponential value generating unit; and a second scaling unit coupled to the mean value generating unit and selectively coupled to the calibration apparatus, for multiplying the averaged value by the second parameter to generate the BEP.

According to the claimed invention, a BEP estimating system for determining the BEP of a received signal is disclosed. The BEP estimating system comprises: a soft equalizer for generating a plurality of soft outputs according to the received signal; a calibration apparatus for deriving a first parameter and a second parameter, wherein the second parameter is relative to the first parameter; a first computing circuit coupled to the soft equalizer and selectively coupled to the calibration apparatus, for generating a plurality of computing values according to the soft outputs and the first parameter; an exponential value generating unit coupled to the first computing circuit, for generating a plurality of exponential values according to the computing values respectively, where the shifter shifts a binary bit “1” └V1ᵢ┘ times to obtain a exponential value 2^{└V1}^{ᵢ}^{┘} according to a computing value V1ᵢ; and a second computing circuit coupled to the exponential value generating unit and selectively coupled to the calibration apparatus, for generating the BEP according to a plurality of exponential values and the second parameter.

According to the claimed invention, a BEP estimating method for determining the BEP of a received signal is disclosed. The bit error probability estimating method comprises: (a) equalizing the received signal to generate a plurality of soft outputs; (b) deriving a first parameter and a second parameter, wherein the second parameter is relative to the first parameter; and (c) determining the BEP according to the soft outputs, the first parameter, and the second parameter.

According to the claimed invention, a BEP estimating method for determining the BEP of a received signal is disclosed. The bit error probability estimating method comprises: (a) equalizing the received signal to generate a plurality of soft outputs; (b) deriving a first parameter and a second parameter, wherein the second parameter is relative to the first parameter; (d) generating a plurality of absolute values of the soft outputs; (e) multiplying each of the absolute values by the first parameter to generate a plurality of computing values; (f) generating a plurality of exponential values according to the computing values respectively, where a exponential value is substantially equal to 2 to the power of a computing value; (g) accumulating and averaging the exponential values to obtain an averaged value; and (h) multiplying the averaged value by the second parameter to generate the BEP.

According to the claimed invention, a BEP estimating method for determining the BEP of a received signal is disclosed. The bit error probability estimating method comprises: (a) equalizing the received signal to generate a plurality of soft outputs; (b) deriving a first parameter and a second parameter, wherein the second parameter is relative to the first parameter; (c) scaling the soft outputs according to the first parameter to generate a plurality of computing values; (d) generating a plurality of exponential values according to the computing values respectively, where each exponential value is generated by shifting a binary bit “1” └V1ᵢ┘ times according to a computing value V1ᵢ; (e) scaling an averaged value of the exponential values according to the second parameter to generate the BEP.

The BEP estimating system and method calculates two parameters in a calibration procedure in the beginning. Next, the BEP estimating system utilizes the two parameters and the soft outputs of the soft equalizer to estimate the BEP. Because the two parameters are designed for simplifying the operation of calculating the BEP, the computation of the BEP estimating system is reduced. Besides, the calibration apparatus is selectively coupled to other components of the BEP estimating system. In other words, the two parameters are calculated only in a calibration procedure. Therefore power consumption of the calibration apparatus is saved, as the calibration apparatus is only used at the beginning of the BEP estimation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the BEP estimating system according to a preferred embodiment of the present invention.

FIG. 2 is a schematic diagram of the computing module shown in FIG. 1.

FIG. 3 is a schematic diagram of the BEP estimating system in the calibration procedure.

FIG. 4 is a flow chart showing the operation of the calibration apparatus according to the preferred embodiment.

FIG. 5 is a plot of the actual BEP and the estimated BEP.

### DETAILED DESCRIPTION

The key feature of the present invention is to provide a low-complexity method and system for the estimation of the bit error probability (BEP). The bit error probability estimating system is capable of calculating the BEP according to a mathematical model derivation with less computation according to the present invention. Moreover, the calibration scheme of the present invention can accommodate different equalizer designs. Furthermore, the flexible and robust technology of the BEP estimation and calibration is suitable for Enhanced GPRS (EGPRS) communication system or any other cellular communication.

The mathematical model derivation process of the present invention is shown in the following equation:

$$\begin{matrix}E [ BEP ] = E [ \frac{1}{1 + {ⅇ}^{{a}^{- 1} \cdot \vert {L}_{i} \vert}} ] \\ \approx E [ {ⅇ}^{- b \cdot {a}^{- 1} \cdot ( \vert {L}_{i} \vert + c )} ] \\ = {ⅇ}^{- b \cdot {a}^{- 1}} \cdot E [ {2}^{- b \cdot {a}^{- 1}} {log}_{2} e \cdot \vert {L}_{i} \vert ] \\ \approx {k}_{2} \cdot E [ {2}^{- ⌊ {k}_{1} \cdot \vert {L}_{i} \vert ⌋} ]\end{matrix} \qquad Equation ( 3 )$$

According to Equation (3), without the complicated calculation of the dividing process and exponential process of the conventional method, the present invention can estimate the BEP simply by utilizing the parameters k₁, k₂, and a plurality of soft outputs Lᵢ. In Equation (3), b and c are constants for adjustments. The constant b is to adjust the scaling of exponent, and the constant c is to adjust the offset of the exponent. In this invention, BEP can be easily estimated through utilizing k₁ and k₂.

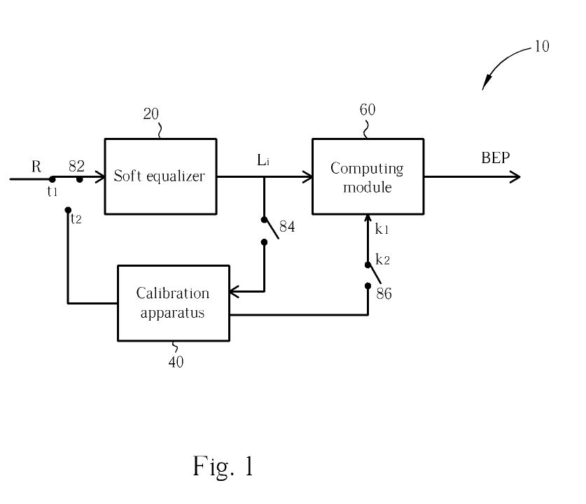

Please refer to FIG. 1. FIG. 1 is a schematic diagram of the BEP estimating system 10 according to a preferred embodiment of the present invention. The BEP estimating system 10 comprises a soft equalizer 20, a calibration apparatus 40, a computing module 60, and three switches 82, 84, and 86. According to the preferred embodiment, the BEP estimating system 10 is applied in a mobile handset. Owing to the operation of the soft equalizer 20 being well known to one skilled in the art, the description of the soft equalizer 20 is omitted. The calibration apparatus 40 is coupled to the soft equalizer 20 and the computing module 60 in a calibration procedure (i.e. the switch 82 is connected to the terminal t2, and the switches 84, 86 are closed) in order to generate the parameters k₁ and k₂. After the computing module 60 has memorized the parameters k₁ and k₂ received from the calibration apparatus 40, the calibration apparatus 40 may not be coupled to the soft equalizer 20 and the computing module 60 anymore (i.e. the switch 82 is connected to the terminal t1, and the switches 84 and 86 are opened). At the same time, the mobile handset is capable of utilizing the soft equalizer 20 and the computing module 60 to receive data R and generate the BEP corresponding to the received data R. The description of the calibration procedure will be detailed in the following paragraphs.

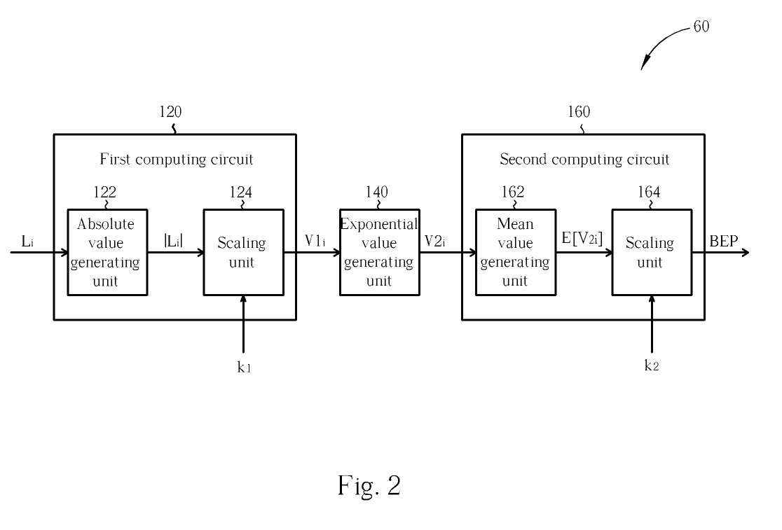

Please refer to FIG. 2. FIG. 2 is a schematic diagram of the computing module 60 shown in FIG. 1. According to the preferred embodiment, the computing module 60 comprises a first computing circuit 120, an exponential value generating unit 140, and a second computing circuit 160. Firstly, the first computing circuit 120 generates a computing value V1ᵢ according to the soft output Lᵢ of the soft equalizer 20 and the first parameter k₁ of the calibration apparatus 40. Secondly, the exponential value generating unit generates an exponential value V2ᵢ according to the computing value V1ᵢ. In a preferred embodiment, the exponential value V2ᵢ is substantially equal to 2 to the power of the computing value V1ᵢ (i.e. V2ᵢ≈2^{V1i}). Finally, when the second computing circuit 160 receives a plurality of exponential values V2ᵢ, the second computing circuit 160 generates the BEP according to the plurality of exponential values V2ᵢ and the parameter k₂ of the calibration apparatus 40.

According to the preferred embodiment, the first computing circuit 120 comprises an absolute value generating unit 122, and a scaling unit 124. The absolute value generating unit 122 is utilized to generate an absolute value of its input data (i.e., the soft output Lᵢ). The scaling unit 124 adjusts the inputted absolute value |Lᵢ| according to the parameter k₁ to generate the computing value V1ᵢ. The operation of the absolute value generating unit 122 and the scaling unit 124 are shown in the following Equation:
V1ᵢ=k₁·|Lᵢ| Equation (4)

According to the preferred embodiment, the exponential value generating unit 140 is realized by a binary shifter. The binary shifter generates the exponential value V2ᵢ by binary shifting a bit “1” └k₁·|Lᵢ|┘ times. The operator └┘ denotes so-called rounding function. Therefore, the binary shifter can easily calculate the 2 to the power of the rounded integer. Owing to the computing complexity of binary shift being lower than the complexity of the exponential process, the operation speed of the BEP estimating system 10 is significantly raised according to the present invention. Please note that the method for generating the exponential value V2ᵢ is not limited to utilize the rounding function, and other functions capable of generating an integer with substantially the same value as the input value can be utilized in the present invention.

According to the preferred embodiment, the second computing circuit 160 comprises a mean value generating unit 162 and a scaling unit 164. After the mean value generating unit 162 has received a predetermined number of exponential values V2ᵢ, the mean value generating unit 162 calculates an averaged value E[V2ᵢ] corresponding to the mean of the exponential values V2ᵢ. Next, the scaling unit 164 adjusts the averaged value E[V2ᵢ] using the parameter k₂ to generate the BEP. The operation of the mean value generating unit 162 and a scaling unit 164 are shown in the following equation:
BEP=k₂·E[V2ᵢ] Equation (5)

As a result, Equation (3) for estimating the BEP is realized by the computing module 60.

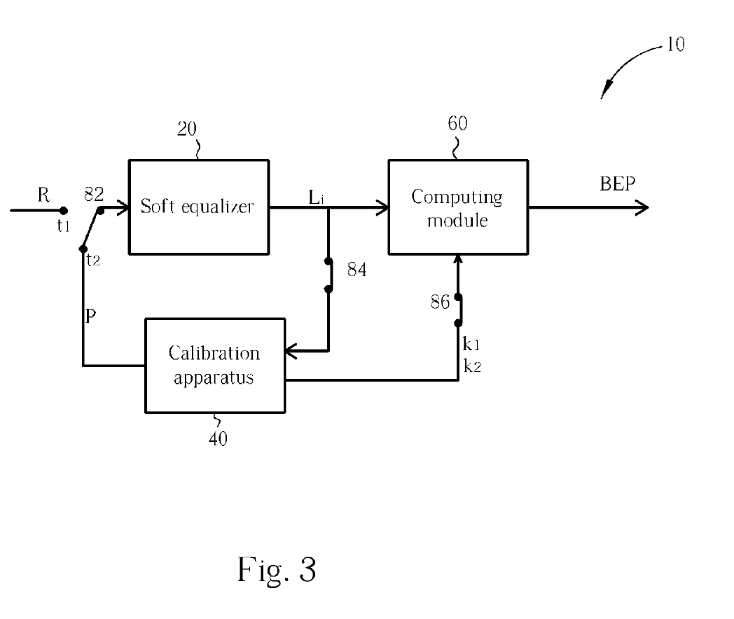

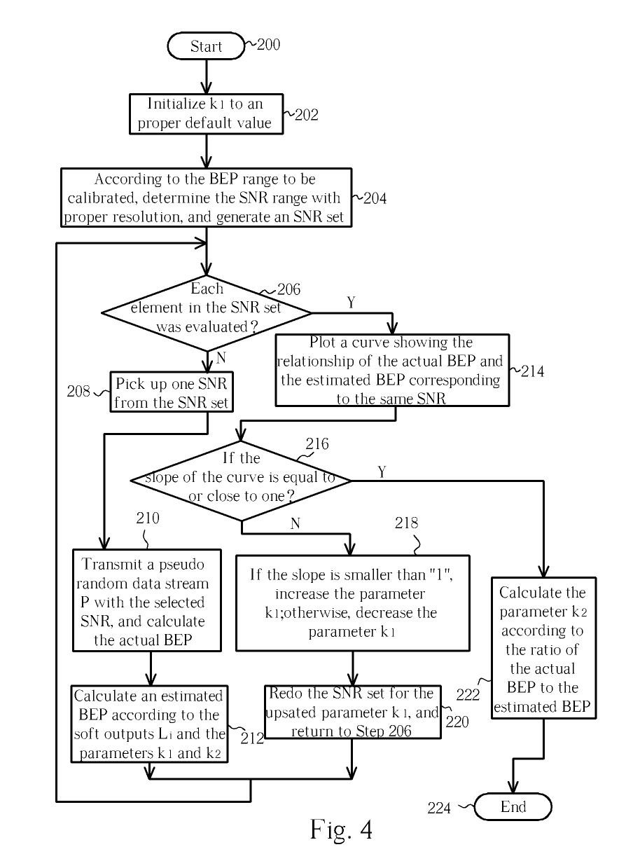

Please refer to FIG. 3. FIG. 3 is a schematic diagram of the BEP estimating system 10 in the calibration procedure. As shown in FIG. 3, the switch 82 is connected to the terminal t2, and the switches 84 and 86 are closed. Firstly the calibration apparatus 40 transmits a pseudo random data stream P to the soft equalizer 20 with a predetermined SNR (Signal to Noise Ratio), and the soft equalizer 20 generates a plurality of soft outputs Lᵢ corresponding to the pseudo random data stream P. Secondly, the calibration apparatus 40 compares the pseudo random data stream P with the soft outputs Lᵢ to generate an actual BEP corresponding to the predetermined SNR. Thirdly, the calibration apparatus 40 utilizes a plurality of actual BEPs with different SNR to derive a mathematical model similar to the ideal mathematical model of the BEP. Finally, the desired parameters k₁ and k₂ are generated according to the mathematical model. Please refer to FIG. 4. FIG. 4 is a flow chart of the operation of the calibration apparatus 40 according to the preferred embodiment. The operation of the calibration apparatus 40 is shown in the following steps:

Step 200: Start.

Step 202: Initialize the parameter k₁ to a proper default value.

Step 204: According to the BEP range to be calibrated, determine the SNR range with proper resolution, and generate an SNR set.

Step 206: If each element of the SNR set was evaluated, proceed to Step 214; otherwise, proceed to Step 208.

Step 208: Select one SNR from the SNR set.

Step 210: Transmit a pseudo random data stream P through the channel with the selected SNR, and calculate the actual BEP by comparing the pseudo random data stream P and the related soft outputs Lᵢ.

Step 212: Calculate an estimated BEP according to the soft outputs Lᵢ corresponding to the pseudo random data stream P and the parameters k₁ and k₂, wherein k₂ is equal to “1”, and proceed to Step 206.

Step 214: Plot a curve showing the relationship of the actual BEP and the estimated BEP corresponding to the same SNR.

Step 216: If the slope of the curve is equal to or close to one, proceed to Step 222; otherwise, proceed to Step 218.

Step 218: If the slope is smaller than “1”, increase the parameter k₁; otherwise, decrease the parameter k₁.

Step 220: Redo SNR set for the updated parameter k₁, and return to Step 206.

Step 222: Calculate the parameter k₂ according to the ratio of the actual BEP to the estimated BEP.

Step 224: End.

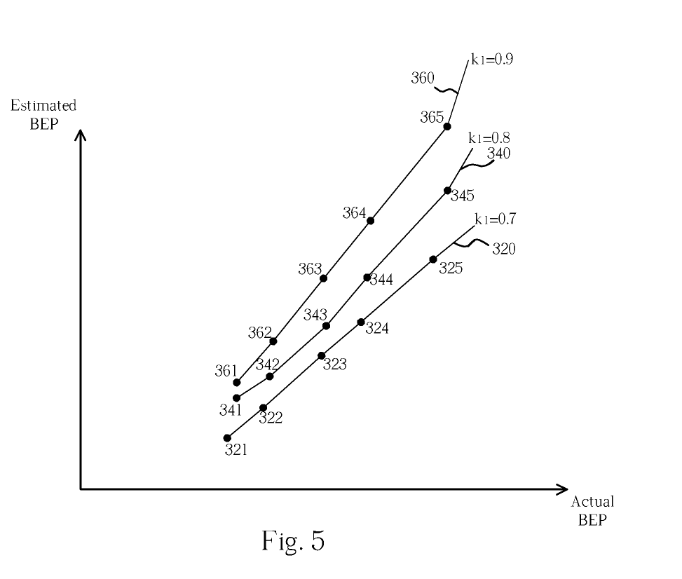

Please refer to FIG. 4 and FIG. 5. FIG. 5 is a plot of the actual BEP and the estimated BEP for performing the calibration procedure according to the preferred embodiment. Assume that the SNR set is [5 10 15 20 25] dB, and the initial parameter kᵢ is equal to 0.9. In the beginning of the calibration process, the SNR is selected to be 5 dB, then the corresponding actual BEP and estimated BEP relate to the point 365. When the SNR is selected to be 10 dB, the corresponding actual BEP and estimated BEP relate to the point 364. In the same manner, when the SNR is selected to be 15 dB, 20 dB, and 25 dB in turn, the corresponding actual BEP and the estimated BEP respectively relate to the points 363, 362, and 361. After all elements of the SNR set have been selected, the curve 360 is generated by connecting the points 361, 362, 363, 364, and 365. According to the present embodiment, the slope of the curve 360 is greater than one. As a result, the parameter k₁ is reduced to 0.8. Then, the calibration apparatus 40 redo the SNR set for the updated parameter k₁, and generates the curve 340 in the same manner. If the slope of the curve 340 is still greater than one, the parameter k₁ is adjusted to 0.7. Then, the calibration apparatus 40 generates the curve 320 accordingly. As the slope of the curve 320 is very close to one, the parameter k₁ is determined to be 0.7, and the parameter k is determined according to the following equation:

$${k}_{2} = \frac{E [ BEP ]}{E [ {2}^{- ⌊ {k}_{1} \cdot \vert {L}_{i} \vert ⌋} ]} \qquad Equation ( 6 )$$

As a result, the parameters k₁ and k₂ are determined by performing the calibration procedure.

The BEP estimating system and method initially calculates two parameters in a calibration procedure according to the present invention. Next, the BEP estimating system utilizes the two parameters and the soft outputs of the soft equalizer to estimate the BEP. The computing amount of the BEP estimating system is reduced because the two parameters are designed for simplifying the operation of calculating the BEP. Additionally, the calibration apparatus is selectively coupled to other components of the BEP estimating system. In other words, the two parameters are calculated only in a calibration procedure. In summary, the power consumption of the BEP estimating system according to the present invention is reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A bit error probability (BEP) estimating system, for determining the BEP of a received signal, the BEP estimating system comprising:
a soft equalizer for generating a plurality of soft outputs according to the received signal;
a calibration apparatus for deriving a first parameter and a second parameter, wherein the second parameter is relative to the first parameter; and
a computing module, coupled to the soft equalizer and selectively coupled to the calibration apparatus, for determining the BEP according to the soft outputs, the first parameter, and the second parameter.

2. The bit error probability estimating system of claim 1, wherein the computing module comprises:
an absolute value generating unit, coupled to the soft equalizer, for generating a plurality of absolute values of the soft outputs;
a first scaling unit, coupled to the absolute value generating unit, for multiplying each absolute value by the first parameter to generate a plurality of computing values;
an exponential value generating unit, coupled to the first scaling unit, for generating a plurality of exponential values according to the computing values respectively, where a exponential value is substantially equal to 2 to the power of a computing value;
a mean value generating unit, coupled to the exponential value generating unit, for generating an averaged value of the exponential values outputted from the exponential value generating unit; and
a second scaling unit, coupled to the mean value generating unit, for multiplying the averaged value by the second parameter to generate the BEP.

3. The bit error probability estimating system of claim 2, wherein the exponential value generating unit generates a rounding value └V1ᵢ┘ of a computing value V1ᵢ, and generates an exponential value equal to 2 to the V1ᵢ-th power, expressed as 2^{└V1}^{ᵢ}^{┘}

4. The bit error probability estimating system of claim 3, wherein the exponential value generating unit shifts a binary bit “1” └V1_{i┘} times to obtain the exponential value expressed as 2^{└V1}^{_{i┘}}

5. The bit error probability estimating system of claim 1 being applied to a mobile handset.

6. The bit error probability estimating system of claim 1, wherein the received signal is an EGPRS signal.

7. A bit error probability (BEP) estimating system, for determining the BEP of a received signal, the BEP estimating system comprising:
a soft equalizer for generating a plurality of soft outputs according to the received signal;
a calibration apparatus for deriving a first parameter and a second parameter, wherein the second parameter is relative to the first parameter;
an absolute value generating unit, coupled to the soft equalizer, for generating a plurality of absolute values of the soft outputs;
a first scaling unit, coupled to the absolute value generating unit and selectively coupled to the calibration apparatus, for multiplying each absolute value by the first parameter to generate a plurality of computing values;
an exponential value generating unit, coupled to the first scaling unit, for generating a plurality of exponential values according to the computing values respectively, where a exponential value is substantially equal to 2 to the power of a computing value;
a mean value generating unit, coupled to the exponential value generating unit, for generating an averaged value of the exponential values outputted from the exponential value generating unit; and
a second scaling unit, coupled to the mean value generating unit and selectively coupled to the calibration apparatus, for multiplying the averaged value by the second parameter to generate the BEP.

8. A bit error probability (BEP) estimating system, for determining the BEP of a received signal, the BEP estimating system comprising:
a soft equalizer for generating a plurality of soft outputs according to the received signal;
a calibration apparatus for deriving a first parameter and a second parameter, wherein the second parameter is relative to the first parameter;
a first computing circuit, coupled to the soft equalizer and selectively coupled to the calibration apparatus, for generating a plurality of computing values according to the soft outputs and the first parameter;
an exponential value generating unit, coupled to the first computing circuit, for generating a plurality of exponential values according to the computing values respectively, where the exponential value generating unit shifts a binary bit “1” └V1ᵢ┘ times to obtain an exponential value 2^{└V1}^{ᵢ}^{┘} according to a computing value V1ᵢ and
a second computing circuit, coupled to the exponential value generating unit and selectively coupled to the calibration apparatus, for generating the BEP according to a plurality of exponential values and the second parameter.

9. The bit error probability estimating system of claim 8, wherein the first computing circuit comprises:
an absolute value generating unit, coupled to the soft equalizer, for generating a plurality of absolute values of the soft outputs; and
a first scaling unit, coupled to the absolute value generating unit and selectively coupled to the calibration apparatus, for multiplying each absolute value by the first parameter to generate the plurality of computing values.

10. The bit error probability estimating system of claim 8, wherein the second computing circuit comprises:
a mean value generating unit, coupled to the exponential value generating unit, for generating an averaged value of the exponential values; and
a second scaling unit, coupled to the mean value generating unit and selectively coupled to the calibration apparatus, for multiplying the averaged value by the second parameter to generate the BEP.

11. A bit error probability (BEP) estimating method for determining the BEP of a received signal, the bit error probability estimating method comprising:
(a) equalizing the received signal to generate a plurality of soft outputs;
(b) deriving a first parameter and a second parameter, wherein the second parameter is relative to the first parameter; and
(c) determining the BEP according to the soft outputs, the first parameter, and the second parameter.

12. The bit error probability estimating method of claim 11, wherein the step (c) comprises:
(d) generating a plurality of absolute values of the soft outputs;
(e) multiplying each of the absolute value by the first parameter to generate a plurality of computing values;
(f) generating a plurality of exponential values according to the computing values respectively, where a exponential value is substantially equal to 2 to the power of a computing value;
(g) accumulating and averaging the exponential values of the soft outputs to obtain an averaged value; and
(h) multiplying the averaged value by the second parameter to generate the BEP.

13. The bit error probability estimating method of claim 12, wherein the step (f) further comprises:
(i) calculating a rounding values └V1ᵢ┘ of a computing values V1ᵢ; and
(j) obtaining the exponential value, being equal to 2 to the V1ᵢ-th power, expressed as

14. The bit error probability estimating method of claim 13, wherein the step (j) further comprises: shifting a binary bit “1” └V1ᵢ┘ times to generate an exponential value 2^{└V1}^{ᵢ}^{┘}

15. The bit error probability estimating method of claim 11, wherein the step (b) further comprises:
(k) tuning the first parameter and the second parameter by performing a calibration procedure.

16. The bit error probability estimating method of claim 11 being applied in a mobile handset.

17. The bit error probability estimating method of claim 11, wherein the received signal is an EGPRS signal.

18. A bit error probability (BEP) estimating method for determining the BEP of a received signal, the bit error probability estimating method comprising:
(a) equalizing the received signal to generate a plurality of soft outputs;
(b) deriving a first parameter and a second parameter, wherein the second parameter is relative to the first parameter;
(d) generating a plurality of absolute values of the soft outputs;
(e) multiplying each of the absolute values by the first parameter to generate a plurality of computing values;
(f) generating a plurality of exponential values according to the computing values respectively, where a exponential value is substantially equal to 2 to the power of a computing value;
(g) accumulating and averaging the exponential values to obtain an averaged value; and
(h) multiplying the averaged value by the second parameter to generate the BEP.

19. A bit error probability (BEP) estimating method for determining the BEP of a received signal, the bit error probability estimating method comprising:
(a) equalizing the received signal to generate a plurality of soft outputs;
(b) deriving a first parameter and a second parameter, wherein the second parameter is relative to the first parameter;
(c) utilizing the soft outputs and the first parameter to generate a plurality of computing values;
(d) generating a plurality of exponential values according to the computing values, respectively, where a exponential value is generated by shifting a binary bit “1” └V1ᵢ┘ times according to a computing value V1; (
e) scaling an averaged value of the exponential values according to the second parameter to generate the BEP.
